(19) United States
(12) Patent Application Publication
(10) Pub. No.: US 2004/0078369 A1
(43) Pub. Date: Apr. 22, 2004

(54) Apparatus, method, and medium of a commodity computing high performance sorting machine

(75) Inventors: Richard Stephen Rothstein, McLean, VA (US); Frederick Moore Vinson III, Washington, DC (US); Nicholas James Charles Bowler, Sterling, VA (US)

Correspondence Address: STAAS & HALSEY LLP, SUITE 700, 1201 NEW YORK AVENUE, N.W., WASHINGTON, DC, 20005, US

(73) Assignee: American Management Systems, Incorporated, Fairfax, VA

(21) Appl. No.: 10/609,675

(22) Filed: Jul. 1, 2003

Related U.S. Application Data
(60) Provisional application No. 60/393,065, filed on Jul. 2, 2002.

(51) Int. Cl. G06F 7/00

(52) U.S. Cl. 707/7

(57) ABSTRACT

A method of a computer system configured to sort data analyzes characteristics of storage system components of the computer system and the data to be sorted. A maximum number of sending processors of the storage system components is determined based on the characteristics and the data to be sorted. A control structure for the sending processors is determined based on the characteristics, the data, the characteristics and maximum number of sending and receiving processors, and load on the sending and receiving processors. The load is balanced across the sending processors and across the receiving processors. The storage system components are configured based on the characteristics, the data, the maximum number of sending processors, and the load, such that each receiving processor of the storage system components of the computer system is dedicated to a single disk or set of disks. The unsorted data is then received by the sending processors, which transmit the unsorted data to the receiving processors based on the control structure. The receiving processors then divide the unsorted data into sort pieces. The receiving processors then sort the sort pieces. Each of the receiving processors sorts a different sort piece than other of the receiving processors. The receiving processors then merge the sorted sort pieces into merged and sorted data. The merged sorted data is then stored by the receiving processors.

### CROSS-REFERENCE TO RELATED APPLICATIONS

This application is related to GAP DETECTOR DETECTING GAPS BETWEEN TRANSACTIONS TRANSMITTED BY CLIENTS AND TRANSACTIONS PROCESSED BY SERVERS, U.S. Ser. No. 09/922,698, filed Aug. 7, 2001, the contents of which are incorporated herein by reference.

This application is related to AN IN-MEMORY DATABASE FOR HIGH PERFORMANCE, PARALLEL TRANSACTION PROCESSING, attorney docket no. 1330.1110, U.S. Ser. No. 10/193,672, by Joanes Bomfim and Richard Rothstein, filed Jul. 12, 2002, the contents of which are incorporated herein by reference.

This application is related to HIGH PERFORMANCE TRANSACTION STORAGE AND RETRIEVAL SYSTEM FOR COMMODITY COMPUTING ENVIRONMENTS, attorney docket no. 1330.1111/GMG, U.S. Ser. No. 10/193,671, by Joanes Bomfim and Richard Rothstein, filed Jul. 12, 2002, the contents of which are incorporated herein by reference.

This application is related to U.S. Provisional application entitled HIGH PERFORMANCE DATA EXTRACTING, STREAMING AND SORTING, attorney docket no. 1330.1113P, U.S. Ser. No. 60/393,065, by Joanes Bomfim, Richard Rothstein, Fred Vinson, and Nick Bowler, filed Jul. 2, 2002, the contents of which are incorporated herein by reference and priority to which is claimed.

### BACKGROUND OF THE INVENTION

1. Field of the Invention

The present invention is directed to computing systems storing and retrieving large amounts of data, and, more particularly, to computing systems which store and retrieve large amounts of data while minimizing the time necessary to sort very large amounts of data and the cost of the hardware required to perform the sort.

2. Description of the Related Art

Commodity approaches to performing compute intensive scientific tasks are well documented. Examples abound such as Beowulf clusters (see the world wide web Beowulf.org) and grid computing (see the world wide web gridforum.org, gridcomputing.com, et al.). What has been lacking, however, is the ability to use the capacity of commodity PC clusters to do massive data manipulation tasks required for standard business needs (such as data extraction and sorting).

In the telecommunications industry, large telephone service providers handle hundreds of millions of calls a day. Calls are associated with customer accounts, which are typically billed monthly. One important step in the billing process is to sort the data describing each phone call by account. Because of the extremely large volumes concerned, this sort requires enormous computing capacity both in terms memory, processing speed and I/O speed.

Companies struggle with how to economically handle projected growth in call volume. Attempts to address struggles to meet growing call volume projections over a three-to-five-year period with typical mainframe solutions have been unsuccessful because demand typically doubles call volume estimates by the time the mainframe solutions are fully operational. Moreover, implementation of mainframe solutions to meet the foregoing demand is typically expensive, particularly in terms of hardware costs.

These problems are found not only in the telecommunications industry, but in other industries as well.

Software sorting using algorithms to sort one set of data is known in the art. SYNCSORT sorting software is also known in the art.

### SUMMARY OF THE INVENTION

It is an aspect of the present invention to provide a computer system which minimizes the time necessary to sort very large amounts of data while also minimizing the cost of the hardware required to perform the sort.

It is another aspect of the invention to provide a commodity computing solution to create a low-cost managed services environment for application hosting.

A further aspect of the present invention is to provide a way to extract and sort extremely large amounts of data.

Still another aspect of the present invention is to use multiple computer servers and network connections to divide up data sorting such that more data is sorted in less time and at less cost than currently possible with available sorting software and either a single computer or clustered computers.

The above aspects can be attained by a system that analyzes characteristics of storage system components and data, determines a maximum number of computers sending the data to be stored, determines computers to receive the data corresponding to the computers sending the data, determines a control structure based on the sending processors and the receiving processors and load balancing, configures the system components based on the sending processors, the receiving processors, the data, and the load balancing such that 1 receiving processor is dedicated to 1 disk or set of disks, receives the unsorted data by the receivers, and sorts by the different receiving processors the data to be sorted then merges the sorted data, and stores the merged, sorted data.

The above aspects can also be attained by a method of a computer system configured to sort data. The method includes analyzing characteristics of storage system components of the computer system and the data to be sorted. The method determines a maximum number of sending processors based on this analysis. The method also determines a control structure for the sending processors based on the characteristics, the data, the maximum number of sending and receiving processors, and load on the sending and receiving processors. The load is balanced across the sending and receiving processors. The method configures the storage system components based on the characteristics, the data, the maximum number of sending and receiving processors, and the load, such that each receiving processor of the computer system is dedicated to a set of disks (in one embodiment, the receivers each have two pairs of disks—one striped pair on which to write individual sorted files and a second pair on which to write a merged file). The method receives the unsorted data by the sending processors. The method transmits the unsorted data by the sending processors to the receiving processors based on the control structure. The method divides by the receiving processors the unsorted data into sort pieces. The method sorts by the receiving processors the sort pieces. Each of the receiving processors sorts a different sort piece than other of the receiving processors. The method re-assembles by the receiving processors the sorted sort pieces into reassembled sorted data. The method stores by the receiving processors the reassembled sorted data.

The Commodity Computing High Performance Sorting Machine uses a set of standard, commercial “off the shelf” (COTS) computer servers and computer network devices to sort large amounts of data more quickly and for less cost that any other sorting solution available. Due to the recent advances in commodity computing, relatively inexpensive machines are available today with gigabytes of storage, gigabytes of active memory (e.g., RAM), gigabit network communication speeds and gigahertz computer processing speeds. While all these machines and the way they are connected are standard devices and configurations available to anyone today, one aspect of the Commodity Computing High Performance Sorting machine (CCHPSM, or sorting machine) of the present invention is the way the CCHPSM uses the relatively inexpensive COTS hardware to minimize sorting time for extremely large amounts of data.

The CCHPSM of the present invention also extracts and sorts extremely large amounts of data that is collected by other computing systems, such as disclosed in U.S. Ser. Nos. 10/193,672 and 10/193,671, the contents of which are incorporated herein by reference. The CCHPSM of the present invention results from study of the characteristics of commodity components (COTS hardware) focusing on how to minimize bottlenecks in the process.

The Commodity Computing High Performance Sorting Machine is based on analyzing the characteristics of commodity components (COTS hardware) focusing on how to minimize bottlenecks in the process.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 shows an overview of the Commodity Computing High Performance Machine (CCHPSM) of the present invention.

FIG. 2 is a hardware configuration example of the CCHPSM of the present invention.

FIG. 3 is hardware configuration example of a single source pizza box of the CCHPSM of the present invention.

FIG. 4 is a hardware configuration example of a destination pizza box of the CCHPSM of the present invention.

FIG. 5 is a flowchart showing an overview of the software processing flow of the CCHPSM of the present invention.

FIGS. 6A and 6B is a flowchart of the details of the software processing flow of the CCHPSM of the present invention.

### DETAILED DESCRIPTION OF THE PREFERRED EMBODIMENTS

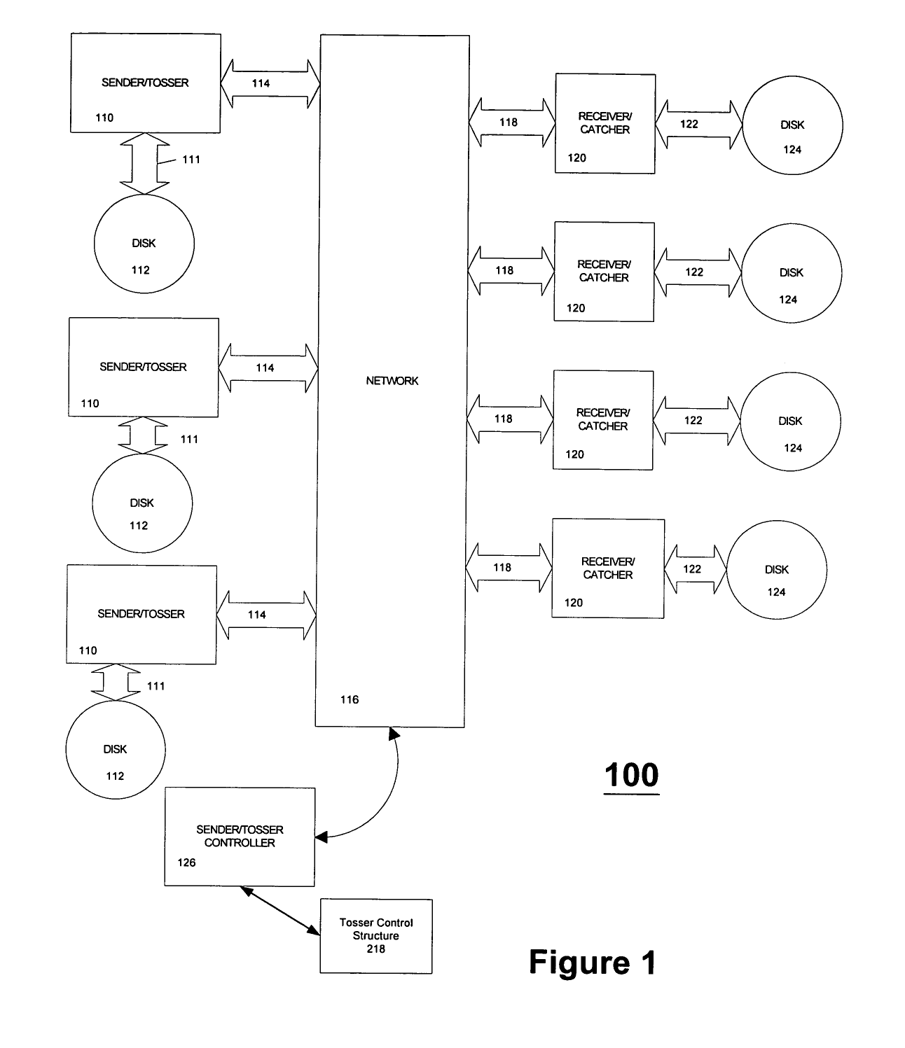

The method and apparatus of the present invention of sorting data by configuring a computer system is explained with reference to FIG. 1.

FIG. 1 shows an overview of the Commodity Computing High Performance Sorting Machine (CCHPSM) of the present invention. More particularly, FIG. 1 shows storage system components of the CCHPSM of the present invention. The storage system components 100 receive data, sort the data, and store the sorted data. These processes may be executed “offline” from the computer system (not shown) supplying the data to the CCHPSM 100 to be sorted.

The CCHPSM 100 shown in FIG. 1 is an example of the present invention, and the features of the present invention are not limited to the example shown in FIG. 1.

As shown in FIG. 1, the CCHPSM 100 of the present invention uses an array of commercial off-the-shelf (COTS) computer servers 110, 120 with a standard configuration of multiple high-speed processors (CPUs), disk drives 112, 124, and network controllers 116 with high-speed network connections 114, 118. Some of the computer servers (the “senders” 110 or “tossers” 110) have the data to be sorted stored on their local disk drives 112, accessible through communication channels 111. The other computer servers (“receivers” 120 or “catchers” 120) are used by the CCHPSM 100 to receive data and store the received data in their respective disk drives 124 through communication channels 122.

Each processor 110, 120 in the present invention executes only 1 process and is dedicated to interfacing (reading or writing) with a disk 112, 124. Also in the present invention, each discreet group of sending processors 110 (that is, those processors included in a given server), has at least one receiver server 120 (with multiple receiving processors) dedicated to it.

The configuration of these servers 110, 120 depends on what commodity computer components are available at the time a CCHPSM 100 is being created. The characteristics (including but not limited to: the number of processors per box, the number of disks, the read/write speed of the disks, the communication channel throughput, the bandwidth of the disk drives, various bus speeds, the bandwidth of the network coupling the components together) of the CCHPSM 100 storage system components and the data to be sorted are first analyzed. Based on the characteristics, potential bottlenecks of a CCHPSM need to be eliminated by properly configure commodity computers with various network communication devices. To maximize throughput of a CCHPSM, a maximum number of sending processors 110 of the storage system components is determined based on the analysis. This analysis and determining can be performed by a user or by a computer program.

A control structure for the sending processors 110 is then determined, either by a user or by the computer program, based on the characteristics, the data, the maximum number of sending processors 110, and load on the sending processors 110. The load is balanced across the sending processors 110 since data is split across disk drives and each sending processor handles one of the disk drivers. The load is balanced across the receiving processors by taking into account the amount of input data per high-level sort criterion and the characteristics of each receiver.

The configuration of the storage system components 100 of the CCHPSM of the present invention is determined based on the characteristics, the data, the maximum number of sending processors 110, and the load, such that each receiving processor 120 of the storage system components 100 of the computer system is dedicated to a single disk 124 or set of disks 124.

In performing the analysis of the characteristics, for example, the bandwidth of a server's 110, 120 disk controllers (not shown in FIG. 1) should exceed the aggregate throughput of a server's disk drives 112, 124, respectively. In an example of the present invention presented herein below, disk drives 112, 114 capable of reading 50 megabytes of data per second (50 MB/sec) are used. Each of the sending servers 110 in the example includes three disk drives 112, so a disk controller with a bandwidth of greater than 150 MB/sec (i.e., 3 times 50 MB/sec) is needed.

The configuration of the CCHPSM 100 of the present invention is stored in the sender/tosser controller 126, which may reside on a separate computer or be integrated with the senders 110. The sender/tosser controller (or tosser controller) 126 includes or creates a table of high-level sort key values (such as account number, etc.) of the input data and the receivers 120 that the senders 110 are coupled to. The tosser controller 126 determines the amount of data to be sorted, or receives and stores such information. This determining of the amount of data by the tosser controller 126 is on-going, and is determined as the data to be sorted is collected or once at sort time. One aspect of the present invention is to balance the total amount of data to be sorted across the receivers 120.

The CCHPSM 100 of the present invention executes a process which includes five basic parts or stages: pre-process, send, receive, sort and merge.

### Pre-Process

In the pre-process stage, data is input to the CCHPSM 100 of the present invention, typically from other computer systems (not shown in FIG. 1). Examples of these other computer systems are shown in U.S. Ser. Nos. 10/193,672 and 10/193,671, the contents of which are incorporated herein by reference.

The input data is indexed (if not indexed already) and the index is processed by the tosser controller 126 against the number of receivers 120 and their characteristics (that is, the number of processors per box, the number of disks 112, the read/write speed of the disks 112, the communication channel 111, 114, 116, 118, 122 throughput, the bandwidth of the disk drives 112, 124, etc.) to create a load-balanced tosser control structure stored as a file or as a file stream in memory in the tosser 126 for the sending processes (or “tossers”) 110. This tosser control structure includes one entry for each high-level sort criteria value with the location (TCP/IP address and port number) of the receiving processors 120. The tosser controller 126 identifies how many physical disk drives 112 are on the senders 110 and initiates a sending process on each sender 110 for each physical disk drive 112. The controller 126 also starts the receiving processes (“catchers”), corresponding to the receivers 120 input to this stage, or ensures these processes have already been started. That is, the sending processors 110 receive the unsorted data input to the CCHPSM 100 of the present invention.

The tosser controller 126 determines the load balancing for the tosser control structure by evaluating the amount of data that exists for each high-level sort criterion, the number of receiving processors, and the characteristics of each receiving processor such as speed, bandwidth, etc., such that each receiving processor will receive as its total received data the amount of data which that receiving processor can process in the same amount of time as the other receiving processors can process their received data. For example, a receiving processor that can process twice as much as data in a given amount of time as the other receiving processors would have twice as much data allocated by the control structure to be sent to that receiving processor.

### Send

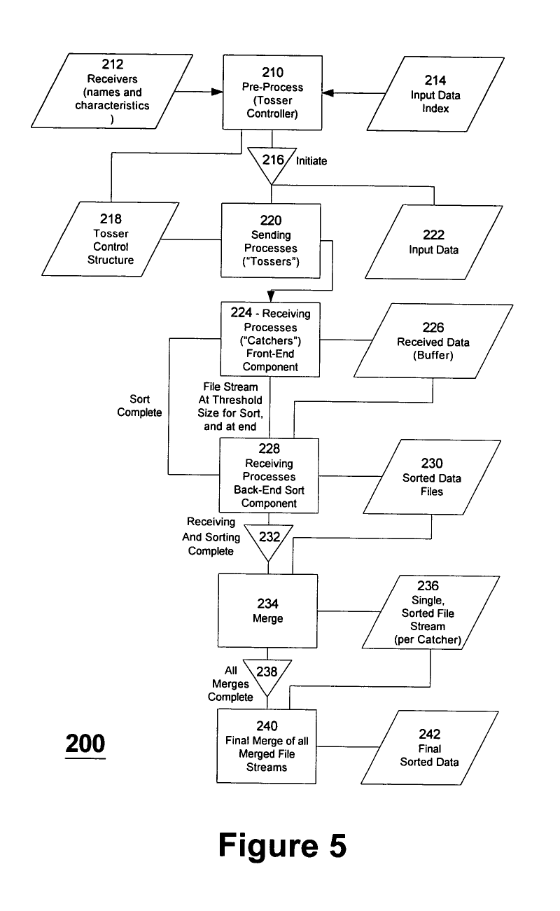

Each sending process (“tosser” 110) is responsible for reading all the data from one physical disk drive 112 and sending each data record to the appropriate receiving process (“catcher” 120) according to the tosser control structure(FIG. 5, 218). Examples of data records are disclosed in U.S. Ser. Nos. 10/193,672 and 10/193,671, the contents of which are incorporated herein by reference. Each tosser 110 receives initial input from the tosser controller 126 with parameters that indicate where to access the tosser control structure, which physical disk drive this tosser 110 is responsible for processing, and which files to process. To optimize the speed of data transfer, the tossers 110 store the tosser control structure (FIG. 5, 218) in memory, use asynchronous blocked file I/O for reading the data from the disks 112, and use asynchronous blocked TCP/IP socket I/O for sending the data to the catchers 120. That is, the sending processors 110 transmit the unsorted data to the receiving processors 120 based on the control structure 126, using streaming disk input/output which continuously fills buffers on the tossers 110. That is, in a continuous manner, the tossers 110 input data from the disks 112 into main memory of the tossers 110, then into buffers of the tossers assigned to receivers 120, then output to the receivers 120.

### Receive

The receiving processes (“catchers” 120) have a front-end and a back-end component. The front-end component monitors a TCP/IP port on its receiver 120 for data transmitted by the tossers 110, and stores the received data in a buffer. Using asynchronous blocked socket I/O, the data is written as quickly as possible from the input buffer to a second buffer in memory in the catcher 120. Once the second buffer has reached a threshold size (determined by input parameters or a default value, and based on optimizing the combination of parameters of the speed of the receiving processor and the size of the processor's memory to achieve the maximum receiving and sorting speed), the buffer is passed to the back-end component of the catcher 120 to be sorted using a commercial “off the shelf” (COTS) sort product available on that platform 120, and stored on the disks 112 (in a striped RAID (Redundant Array of Inexpensive Disks) organization) using asynchronous buffered file I/O. A feature of the present invention is to put all the data into buffers of the maximum size that can be efficiently sorted in memory on a given machine 120. The receiving processors 120, sortiall data received since the beginning or the last receiver sort (whichever was the most recent) and store that into a file. These files may be referred to as sorted pieces of the received data.

Another feature of the present invention is that there is one receiving process (or processor 120) per disk 124. To avoid a slowing of the read/write process between the processor 120 and the disk 124, the disk 124 is dedicated to one processor 120 and is not shared between processors 120, thus avoid spending time on hopping around of the disk head. The above-mentioned example of the present invention used files and file streams of 1-2 GB, thus determining the threshold size for kicking off back-end sorts, since “commodity” computers can currently sort between 1-2 GB of data efficiently in memory.

Still another feature of the present invention is that each receiver 120 has its own processor, its own memory (2-4 GB per processor), and its own dedicated disk driver, all of which allow the process executed by the receiver 120 to pause just long enough to write the data to the disk 124.

### Sort

The catcher 120's back-end component is responsible for reading each buffer created by the front-end component, sorting the read buffer, and saving the sorted data to disk 124. When the back-end sort of a buffer is complete, the catcher's front-end component opens a new buffer for capturing subsequent data. During the sorting time period, the catcher does not read in any further data. The tosser's asynchronous sending process either pauses or repeats sending data to the catcher until the catcher is ready to receive more data. That is, the receiving processors 120 sort the sort pieces, which are a collection of unsorted data records stored in the buffer created by the front-end component. Each of the receiving processors 120 sorts a different sort piece from the current buffer used by the receiving processors 120 to hold the received data of the current instance. Each receiving processor 120 saves the resultant sorted piece to disks 124 that are exclusively assigned to that receiving processor 120.

The CCHPSM 100 of the present invention uses, but does not require the use of, known sorting software to sort each of the sort pieces of data. The CCHPSM 100 can use either commercially-available sorting software or sorting algorithms that are in the public domain. In the CCHPSM 100 of the present invention, multiple computer servers 120 with network connections 116, divide up the sorting such that more data is sorted in less time and at less cost than currently possible with available sorting software and single computer or clustered computers.

### Merge

When all data has been received, the merge process executed by the catcher 120 reads all the individual, sorted files created by the back-end sort component of the receiving processes (“catchers”) 120 and merges the data into a single, sorted file stream. This file stream may be passed directly into some process (for example, a billing system) or written to a file for subsequent processing. That is, the receiving processors 120 merge the sorted sort pieces into merged sorted data, and store the merged sorted data.

In the CCHPSM 100 of the present invention, data is read up to as many as five times (once by the tosser controller 126 if the index does not already exist with the information necessary to create the tosser control structure, once by the tosser 110 to send to the receiver, once by the receiver to merge the sorted files to a merged, sorted file, and once by the final merge) and data is written two or three times (once when first sorted by each receiver, once to the sorted, merge file, and possibly one more time by the final merge). Moreover, because of the pre-process analysis, the CCHPSM 100 of the present invention uses the maximum capability of each component, for example, sorting the data in memory to increase the speed of the sort (by the receiver 120) and, for example, always reading the data in the order in which it is physically written to disk to ensure the maximum disk speed throughput for reads.

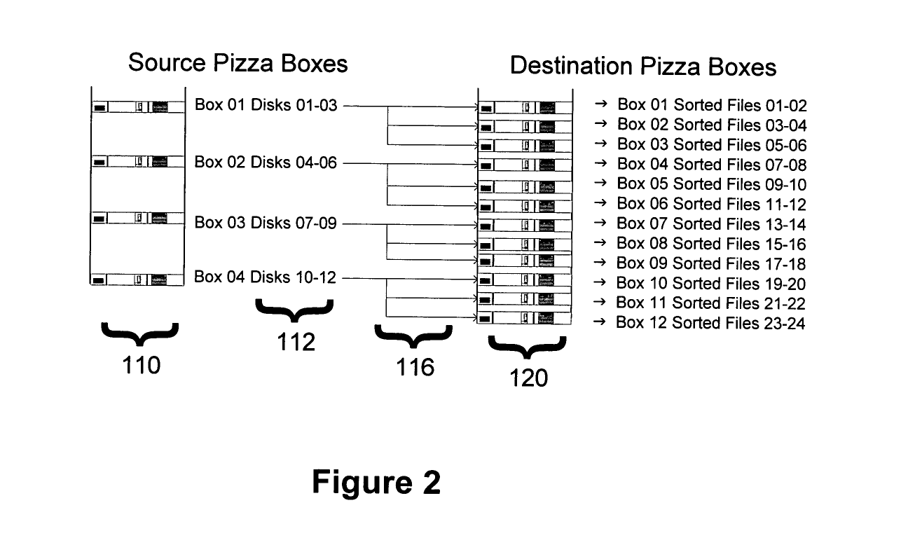

FIGS. 2-4, collectively, show a configuration of a CCHPSM 100 of the present invention based on COTS hardware and used to extract and sort 775 gigabytes of data in one (1) hour. This configuration is not the only way a set of computer servers 110, 120 can be networked to create the Commodity Computing High Performance Sorting Machine 100, but is intended as an example of a configuration that fits the general scheme of the present invention.

FIG. 2 shows a diagram of source “pizza boxes” 110 and destination “pizza boxes” 120 corresponding, respectively, to the tossers 110 and the catcher 120 shown in FIG. 1. A “pizza box” is a server made to fit in a server rack, called a pizza box because of its physical similarity to the size and shape of the boxes used by pizza delivery companies.

To maximize the performance of commodity components included in the CCHPSM 100 of the present invention, the characteristics of these components are first analyzed. Characteristics which are analyzed include the number of processors per box, the number of disks, the read/write speed of the disks, the communication channel throughput, the bandwidth of the disk driver and the bandwidth of the network coupling the components together.

Then the components are carefully combined such that bottlenecks are minimized.

It is initially assumed that dedicated hardware is utilized for the sending and receiving/sorting processes. At the conclusion, options for how to leverage excess capacity are considered.

The following key commodity components are used throughout the example presented in FIGS. 2-4:

73 GB Disk drives capable of streaming data in burst mode at 50 MB/sec;

Striped Disk drive pairs capable of streaming data in burst mode at 100 MB/sec;

Ultra 160 Controllers, having a throughput of 160 MB/sec;

1 u servers (“u” refers to the server dimensions, “1 u” meaning that a server will fit in a single server rack slot) with dual 2.8 GHz XEON processors;

1 gigabit (Gbit) Ethernet connections (assumed to operate at 100 MB/sec).

The example hardware configuration shown in FIGS. 2-4 includes sending (source) servers 110 and receiving/sorting (destination) servers 120. The sending servers 110 primarily host the drives 112 on which the data to be sorted is stored. The receiving/sorting servers 120 host the actual sort. In this example, three sorting servers 120 are utilized per sending server 110.

In the example shown in FIGS. 2-4, the input data is transmitted by 12 disk drives 112 (disks 01-03, 04-06, 07-09, and 10-12) located in 4 sending servers (the Source Pizza Boxes 01, 02, 03, and 04) 110, on which the Tosser Controller 126 and the Tossers 110 execute. The output data is transmitted through network 116 (a 1 Gb Ethernet) to 24 sets of files each on one of 24 pairs of disk drives 124 on 12 sorting servers (the Destination Pizza Boxes) 112.

FIG. 2 shows a pizza box for a sorting machine (or CCHPSM) 100 of the present invention. As shown in FIG. 2, source pizza boxes (tossers) 110 transmit data to be sorted stored on disks 112 through a 1 Gbit Ethernet network 116 to destination pizza boxes (catchers) 120 to perform the sort.

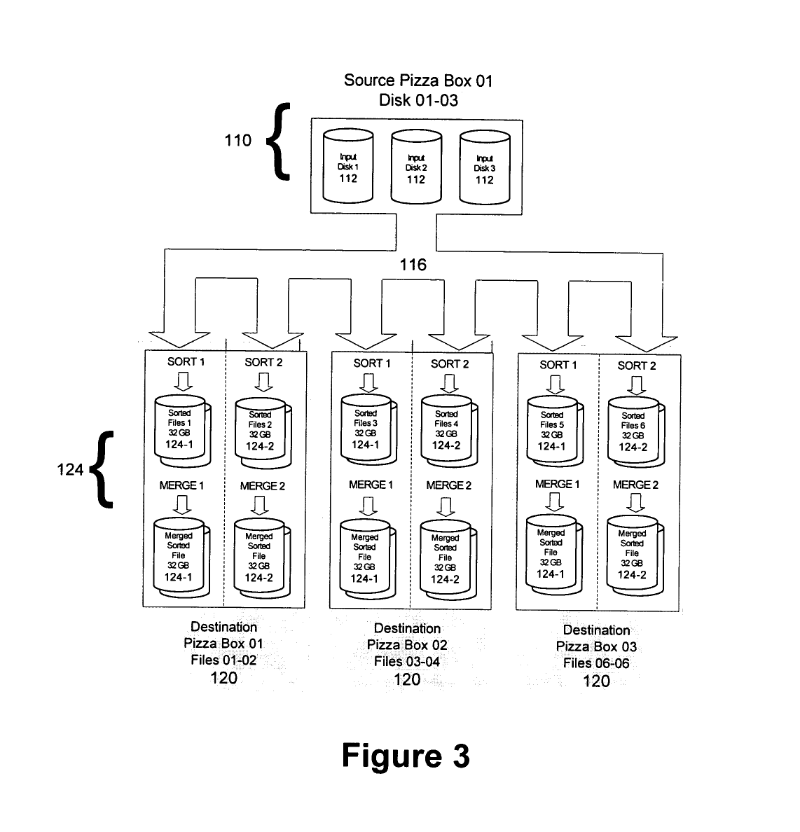

FIG. 3 shows a representation of one of the sending servers 110 and its three receiving/sorting servers 120 as used in the above-mentioned example. In the present invention, each tosser 110 may send data to be sorted to multiple catchers 120 through network 116. This data to be sorted is initially stored on input disks 112, and is transmitted through network 116 to catchers 120. As shown in FIG. 3, the source pizza box 110 is sending the data to three destination pizza boxes 120, each of which respectively hosts 2 receiving processors and 4 pairs of disks 124-1,124-2 and each storing sorted files. Two disks 124-1, 124-2 are shown for each destination pizza box 120 because in the example of FIG. 3, each destination pizza box includes 2 receiving processors (catchers), each of which is dedicated to one of the disks 124. That is, each logical disk 124-1,124-2 shown in FIG. 3 includes a pair of physical disk drives used to stripe the data for faster throughput.

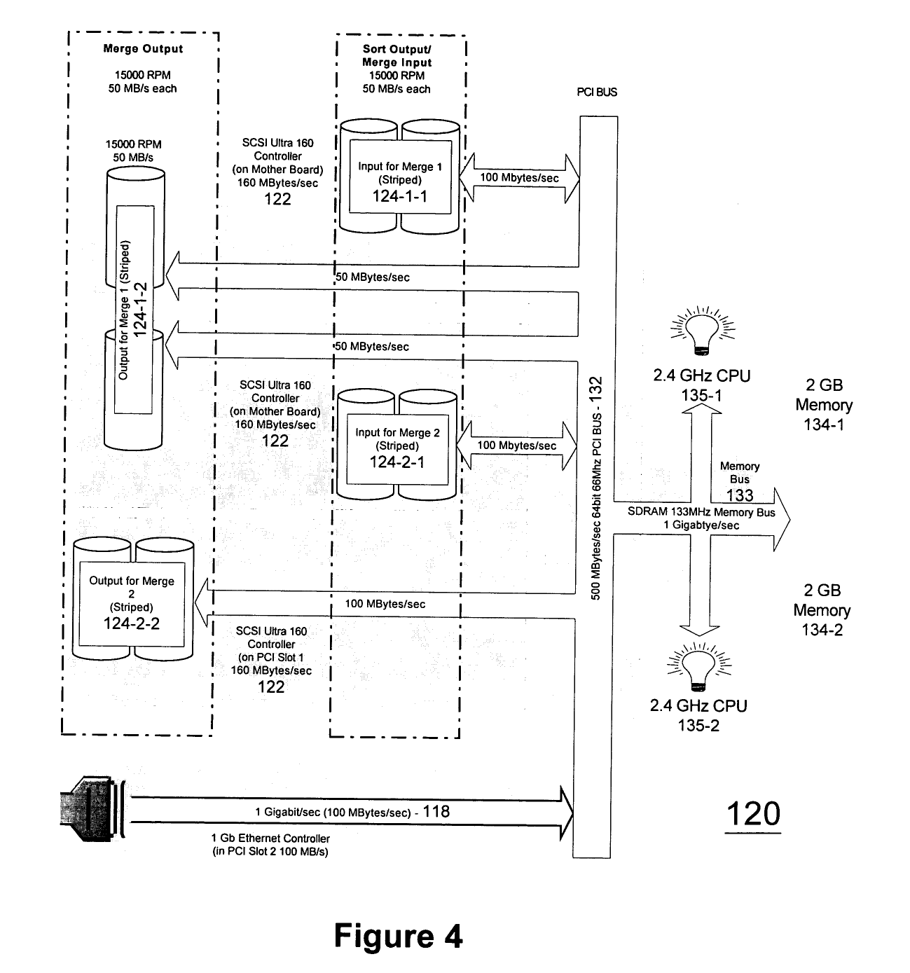

FIG. 4 shows the hardware components of a destination pizza box 120.

All servers used in the example of FIGS. 2-4 include 2.8 GHz XEON processors, at least three (3) on the sending servers 110 and at least two (2) on the receiving servers 120, which provided an economical set-up. Each server 110, 120 also have Ultra 160 disk controllers, with 160 MB/second bandwidth, one (1) on each sending server 110 and three (3) on each receiving server 120, and at least 2 GB of active memory per processor.

Referring now to FIGS. 2-4, the sending servers 110 include three (3) 50 MB/second disk drives 112 so that the aggregate throughput of the three drives 112 is approximately balanced with the disk controller's 160 MB/second bandwidth. This relationship ensures that when data is extracted from the source servers 110 and transmitted to the destination servers 120, the limiting factor in the speed of data transfer is the speed of the disk drives 112, which reflects actual hardware limits of current technology.

The destination servers 120 (shown in FIG. 4) are similar to the source servers 110, with the same processors and controllers, with the principal exception that the destination servers 120 include four (4) pairs of disk drives 124-1-1,124-1-2, 124-2-1, and 124-2-2 and these disk drives are striped. By striping the disk drives, the rate at which data can be read/written to the drives is doubled from 50 MB/sec to 100 MB/sec. This extra speed is used during the actual sort of data.

Referring again to FIG. 4, the unsorted data is received by the destination server 120 through the network controller 118, a 1 Gbit Ethernet Controller located in PCI slot 2, and is transmitted into memory on PCI bus 132 (a 500 Mbytes/sec 64 bit 66 MHz PCI Bus) and memory bus 133 (an SDRAM 133 MHz 1 GB/second memory bus).

The unsorted data, allocated to each of two 2.4 GHz CPUs (135-1 and 135-2) according to the TCP/IP port (socket) from which it was received, is sorted and stored on striped disks 124-1-1 and 124-2-1, respectively, by the CPUs. The speed of each of the disks 124-1-1 and 124-2-1 is 15000 RPM, 50 MB/second.

The sorted data is then read from each of the disks 124-1-1 and 124-2-1 by processing running processors 135-1 and 135-2, respectively, and the sorted data is merged and stored on striped, 15000 RPM, 50 MB/s each disks 124-1-2 (for the process running on 135-1) and 124-2-2 (for the process running on 135-2).

Each of the disks 124 is controlled by a SCSI Ultra 160 Controller (on 160 Mbytes/sec), located either on the mother board (124-1-1,124-2-1,124-1-2) or PCI Slot 1 (124-2-2).

FIG. 5 is a flowchart showing an overview of the software processing flow 200 of the CCHPSM 100 of the present invention.

The software processing flow 200 represents the general flow in the Commodity Computing High Performance Sorting Machine 100.

The Tosser Controller in the “pre-process” phase 210 reads the input data index 214 and the receiver list 212 (“catchers” 120), creates 218 the Tosser Control Structure, and starts 216 the tossers 110. The tossers 110 read 218 the Tosser Control Structure and input data 222. Tossers 220 send each input data record 222 to its assigned catcher 120.

The catchers 120 put 224 each data record received into a buffer 226 while monitoring the buffer's size. When a buffer reaches the threshold size, the catcher 120 sorts 228 it to a file 230 on disk 124. When all data has been received (i.e., all tossers 110 have sent an end-of-data indication) 232, the sorted data files are merged 234 to a single, sorted file stream 236. When all receivers 120 have completed 238, the sorted and merged file streams from each receiver are merged 240 to create the final sorted data stream 242.

The following flowchart 300 breaks down the steps for each of the processes in this overview flowchart.

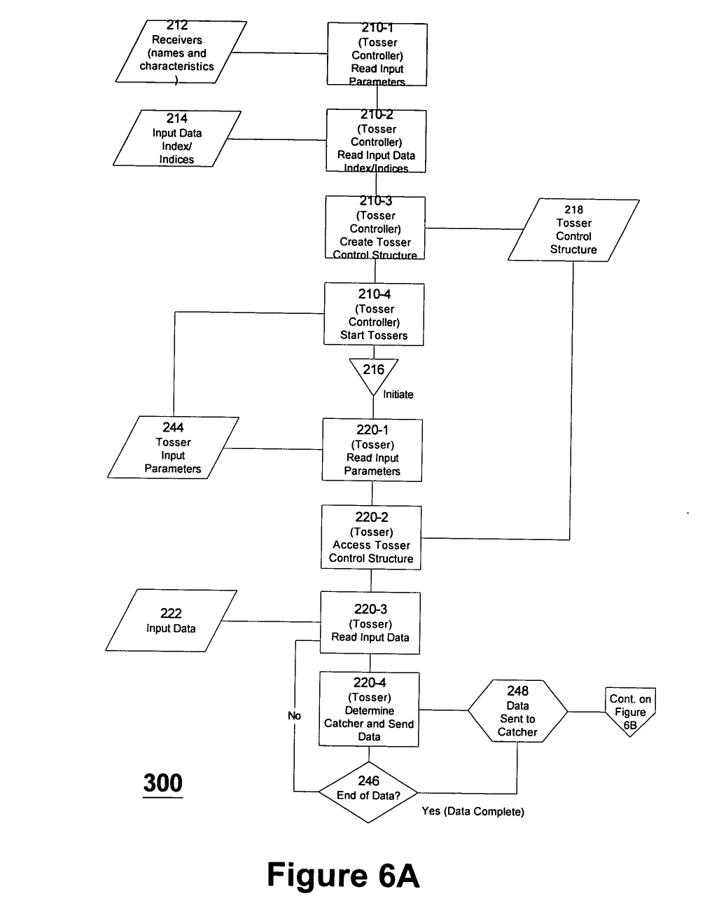

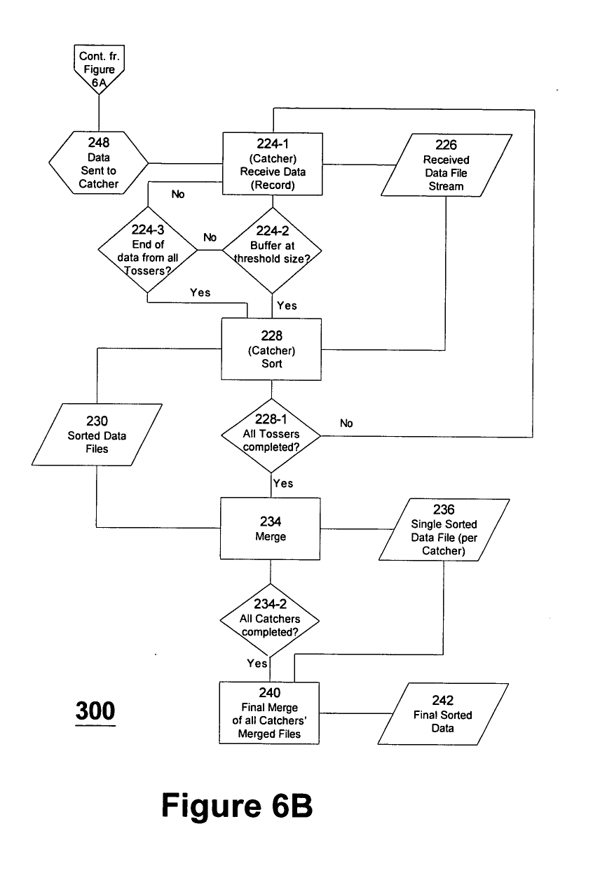

FIGS. 6A and 6B is a flowchart showing the details 300 of the software processing flow of the present invention.

The flowchart of FIGS. 6A and 6B represents the detailed processes performed by the Commodity Computing High Performance Sorting Machine software of the present invention. Processes shown in FIGS. 6A and 6B relate to processes shown in FIG. 5, as indicated.

Referring now to FIGS. 6A and 6B, the Tosser Controller 126 reads 210-1 input including, but not limited to, the list 212 of receiving servers (“catchers” 120) and reads 210-2 the input data index 214. The tosser controller 126 uses this information to create 210-3 the Tosser Control Structure 218 including the catcher 120 for each high-level index value. Finally, having ensured that the receivers 120 are ready, the tosser controller 126 creates 210-4 the Tosser Input Parameters 244, and initiates 216 the tossers 110.

Each tosser 110 receives 220-2 the Tosser Control Structure 126/218 and receives 220-1 input 244 indicating on which disk drive 112 to process which files of data. Each tosser 110 reads 220-3 the files 222, determines 220-4 to which catcher 120 to send the data and sends 248 each record in the files to its assigned catcher 120. When the tosser 110 has completed 246 reading and sending all records from all files, the tosser 110 sends a complete notification to each catcher 120 to which the tosser 110 has sent data.

Each catcher 120 receives 224-1 the sent data (records) by monitoring a particular TCP/IP port on the computer server where the catcher is running and opens 226 a buffer in which data received is stored 226. The catcher 120 receives each data record (or packet of data records), puts the data in its buffer, saves the tosser ID if not already saved, and checks 224-2 the size of its buffer. If the buffer size is equal to or greater than the threshold size 224-2 (set by the user) or if an end of data from all tossers has been received 224-3, the catcher sorts 228 the buffer 226 to a disk file 230. When completion notifications have been received 228-1 from all tossers that have sent data to the catcher, the catcher sorts 228 any data remaining in its buffer, then merges 234 all the sorted data files 230 to a single, sorted file 236 per catcher. After all catchers have completed 234-2 the merge 234, then there is a final merge 240 of all catchers' merged files into final sorted data 242.

An example of the present invention applied to the telecommunications industry is now discussed.

Telephony providers bill customers based on “call detail records” (CDRs). Each CDR describes one phone call. Large Regional Bell Operating Companies (RBOCs) handle hundreds of millions of calls a day. Assuming 500,000,000 calls per day are stored, a CDR requires 1,000 bytes of storage, and accounts are billed once per month with customers divided into 20 bill cycles per month, then during a month with 31 days the provider will need to process about 775 GB of data per bill cycle:

$$\frac{500 M \frac{CDRs}{day} \times 31 \frac{days}{month}}{20 \frac{bill cycles}{month}} = \frac{775 M records}{bill cycle} , or \frac{775 GB of data}{bill cycle}$$

Assuming that within one hour or less, the 775 GB of data for a given bill cycle must be extracted and sorted by account number, call date and type for input into a billing stream. Inexpensive, commercially available PCs, performing in the manner described in the present invention, would provide the ability to extract and sort 775 GBs of data using 16 PCs as described herein above—four PCs each with at least three 2.8 GHz processors (CPUs), three 73 GB, 50 MB/second hard drives, and a 160 MB/second disk controller sorting across a 1 Gbit network to twelve PCs each with at least two 2.8 GHz processors (CPUs), four pairs of striped 73 GB, 50 MB/second disk drives, and three 160 MB/second disk controllers. The use of striping, which means “interleaving or multiplexing data to increase speed” (from the “TechEncyclopedia” at the world wide web techweb.com/encyclopedia/defineterm?term=striping&x=30&y=8) allows the present invention to write across two disk drives at around twice the normal speed of either disk drive alone.

An aspect of the Commodity Computing High Performance Sorting machine, described herein above, combines and uses relatively inexpensive COTS hardware to minimize sorting time and cost for extremely large amounts of data. Sorting software is known in the art that can sort large amounts of data by breaking it up into smaller sorts, then merging it back together to create a single sorted file. However, another aspect of the present invention uses multiple servers optimized to process a sort by intelligently sending data from sending servers to receiving servers, which perform a series of smaller sorts, a local merge, and a final global merge.

In the above-mentioned description of the present invention uses the term computer server to mean a physical box with computer processors and disk drives in it, which is connected to other physical boxes using currently available network technology (such as Ethernet). The CCHPSM of the present invention is described in this manner because these are the computer components that are available as commodities today.

In the future, the same approach may be possible using a configuration that does not resemble the above-mentioned server/network example because of advances in computer server and network technology. It may be possible, for example, to “grow” a biological-based computer that organically contains all the parts of the CCHPSM (i.e., the computer processors, storage, and connections) without the boxes and network connectors. The CCHPSM approach, how to allocate the work across processors and storage devices, would still apply.

The CCHPSM of the present invention includes technology that is faster and less expensive than other available sorting solutions.

For example, known sorting software sorts approximately 25 GB of data per hour per process. On a large mainframe computer known in the art approximately 6 sorts could be executed per hour in parallel without significantly degrading performance, resulting in a total of 150 GB of data sorted per hour. Using 5 of the large mainframe computers (costing approximately $5 million per mainframe, approximately $25 million in total), close to 775 GB of data could be sorted per hour.

In contrast, the hardware cost of a CCHPSM of the present invention would be approximately $293,000. This hardware includes 16 commodity servers (the cost of each DELL POWEREDGE 2650 application servers with two 2.4 gigahertz PENTIUM XEON CPUs and 6 GB of memory is $9,000 for a total of $144,000); 120 73-GB disks (the cost of each 73-GB disk with 50 MB/second access speeds is $875 for a total of $105,000); and a 1 gigabit Ethernet switch plus miscellaneous hardware ($44,000). While the prices of both mainframe computers and commodity computers continue to decline, the overall difference in cost (approximately two orders of magnitude) continues to be large.

The system also includes permanent or removable storage, such as magnetic and optical discs, RAM, ROM, etc. on which the process and data structures of the present invention can be stored and distributed. The processes can also be distributed via, for example, downloading over a network such as the Internet.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method of sorting data by configuring a computer system, comprising:
analyzing characteristics of storage system components of the computer system and the data to be sorted;
determining a maximum number of sending and receiving processors of the storage system components based on the analyzing;
determining a control structure for the sending processors based on the characteristics, the data, the maximum number of sending and receiving processors, and load on the sending processors, wherein the load is balanced across the sending processors;
configuring the storage system components based on the characteristics, the data, the maximum number of sending processors, and the load, such that each sending and receiving processor of the storage system components of the computer system is dedicated to a single disk or set of disks;
receiving the unsorted data by the sending processors;
transmitting the unsorted data by the sending processors to the receiving processors based on the control structure;
dividing by the receiving processors the unsorted data into sort pieces;
sorting by the receiving processors the sort pieces, wherein each of the receiving processors sorts different sort pieces than other of the receiving processors;
merging by the receiving processors the sorted sort pieces into merged sorted data; and
storing by the receiving processors the merged sorted data.

2. The method as in claim 1, wherein the determining a control structure includes determining at least one set of receiving processors for each discreet group of sending processors.

3. The method as in claim 2, wherein the transmitting the unsorted data further comprises tracking by the receiving processors of the sending processors from which the unsorted data is received.

4. The method as in claim 3, wherein the sorting includes storing the unsorted data into buffers, sorting the data in the buffers, and storing the sorted data to the single disk or set of disks.

5. The method as in claim 1, wherein the receiving the unsorted data includes storing the unsorted data on respective disks of the sending processors, wherein each of the sending processors is dedicated to a single disk or set of disks.

6. The method as in claim 5, wherein the analyzing includes analyzing a number of and a configuration of the sending processors, analyzing read/write speed of disks of the sending processors, and analyzing throughput of a communication channel of the storage system components.

7. The method as in claim 5, wherein data stored on the disks of the sending processors and disks of the receiving processors is read from each of the disks in the order in which each of the disks is physically written.

8. The method as in claim 1, wherein the configuring includes balancing the total amount of the unsorted data across the receiving processors.

9. The method as in claim 8, wherein the balancing is executed as the unsorted data is received by the sending processors.

10. The method as in claim 8, wherein the balancing is executed during the sorting of the data.

11. The method as in claim 5, wherein the receiving the unsorted data includes storing the unsorted data on the disks of the sending processors, and the transmitting the unsorted data includes:
reading the unsorted data from the disks of the sending processors,
storing the unsorted data in memory of the sending processors,
reading the unsorted data from the memory of the sending processors,
storing the unsorted data into buffers of the sending processors,
reading the unsorted data from the buffers of the sending processors, and
transmitting the unsorted data to the receiving processors, wherein each of the sending processors including 1 set of buffers for each of the receiving processors.

12. The method as in claim 11, wherein the reading the unsorted data from the disks includes reading the unsorted data using streaming (asynchronous buffered) disk input/output.

13. The method as in claim 11, wherein the transmitting the unsorted data to the receiving processors includes asynchronously transmitting blocks of data from the buffers of the sending processors to the receiving processors.

14. The method as in claim 1, wherein the storing by the receiving processors the merged sorted data includes storing the merged sorted data on disks of the receiving processors configured in a striped RAID configuration.

15. A sorting apparatus coupled with a highly parallel computer system to sort a high volume of business transactions, comprising:
sending machines executing respective send processes transmitting each record of unsorted data and comprising physical disks storing the unsorted data, the send process for each machine reading all of the unsorted data stored on each physical disk of the sending machines and transmitting each record of the unsorted data;
receiving machines executing respective receive processes and receiving the unsorted data transmitted by the sending machine, each of said receive processes comprising a front-end component monitoring a port of its machine for the unsorted data sent by the sending process, and a back-end component writing out the unsorted data into buffers, wherein each of the receiving machines' processors is dedicated to a single disk or set of disks;
a pre-process controller defining a load-balanced control structure of the sorting apparatus by identifying a number of the physical disks coupled to each of the sending machines, and starting the receive process;
a sort process executed subsequent to the receive process, sorting the data records, and saving the sorted data records to disk; and
a merge process which reads all sorted files from the sort processes and merges data into a single, sorted file stream.

16. The sorting apparatus as in claim 15, wherein the input port is a TCP/IP port.

17. A computer readable storage controlling a computer configured to sort data by the functions comprising:
analyzing characteristics of storage system components of the computer system and the data to be sorted;
determining a maximum number of sending processors of the storage system components based on the analyzing;
determining a control structure for the sending processors based on the characteristics, the data, the maximum number of sending processors, and load on the sending processors, wherein the load is balanced across the sending processors;
configuring the storage system components based on the characteristics, the data, the maximum number of sending processors, and the load, such that each receiving processor of the storage system components of the computer system is dedicated to a single disk or set of disks;
receiving the unsorted data by the sending processors;
transmitting the unsorted data by the sending processors to the receiving processors based on the control structure;
dividing by the receiving processors the unsorted data into sort pieces;
sorting by the receiving processors the sort pieces, wherein each of the receiving processors sorts a different sort piece than other of the receiving processors;
merging by the receiving processors the sorted sort pieces into merged sorted data; and
storing by the receiving processors the merged sorted data.

18. The storage as in claim 17, wherein the determining a control structure includes determining at least one set of receiving processors for each discreet group of sending processors.

19. The storage as in claim 18, wherein the transmitting the unsorted data further comprises tracking by the receiving processors of the sending processors from which the unsorted data is received.

20. The storage as in claim 17, wherein the sorting includes storing the unsorted data into buffers, sorting the data in the buffers, and storing the sorted data to the single disk or set of disks.

21. The storage as in claim 17, wherein the receiving the unsorted data includes storing the unsorted data on respective disks of the sending processors, wherein each of the sending processors is dedicated to a single disk or set of disks.

22. The storage as in claim 21, wherein the analyzing includes analyzing a number of and a configuration of the sending processors, analyzing read/write speed of disks of the sending processors, and analyzing throughput of a communication channel of the storage system components.

23. The storage as in claim 21, wherein data stored on the disks of the sending processors and disks of the receiving processors is read from each of the disks in the order in which each of the disks is physically written.

24. The storage as in claim 21, wherein the configuring includes balancing the total amount of the unsorted data across the receiving processors.

25. The storage as in claim 24, wherein the balancing is executed as the unsorted data is received by the sending processors.

26. The storage as in claim 24, wherein the balancing is executed during the sorting of the data.

27. The storage as in claim 17, wherein the storing by the receiving processors the merged sorted data includes storing the merged sorted data on disks of the receiving processors configured in a striped RAID configuration.
